(19) United States
(12) Patent Application Publication
(10) Pub. No.: US 2001/0022548 A1
(43) Pub. Date: Sep. 20, 2001

(54) Transformer having insulation means formed by a mounting plate suitable for a printed circuit

(76) Inventor: Rudolf Josef Hasler, Vienna (AT)

Correspondence Address: Michael E. Marion, c/o U.S. PHILIPS CORPORATION, Intellectual Property Department, 580 White Plains Road, Tarrytown, NY, 10591, US

(21) Appl. No.: 09/769,182

(22) Filed: Jan. 25, 2001

(30) Foreign Application Priority Data
Jan. 27, 2000 (EP) 00890027.6

(51) Int. Cl. H01F 27/30

(52) U.S. Cl. 336/196

(57) ABSTRACT

In a transformer (13) having a primary winding (19) and a secondary winding (20) and a primary magnet core (21) with at least one primary end face (22) and a secondary magnet core (23) with at least one secondary end face (24) and insulation means in a gap (25) between the at least one primary end face (22) and the at least one secondary end face (24), the insulation means are formed with the aid of a mounting plate (26) which is suitable as a mounting plate (26) for a printed circuit.

The invention relates to a transformer as defined in the opening part of claim known 1 and to a power pack as defined in the opening part of claim 5 as well as to an apparatus as defined in the opening part of claim 9.

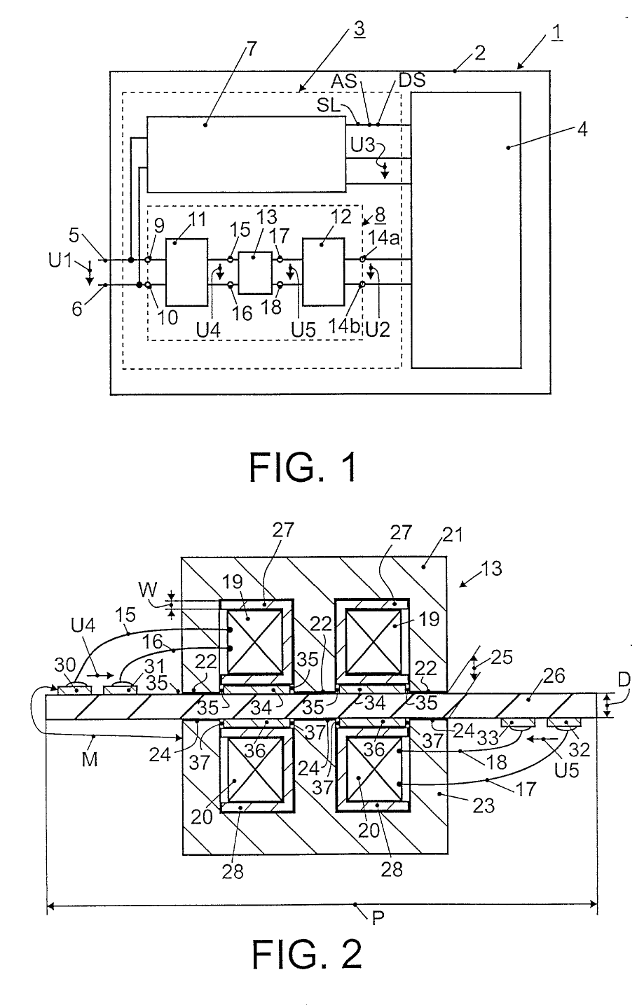

Such a transformer and such a power pack as well as such an apparatus are known from the patent document DE 31 31 105 A1. In the known case, the transformer forms part of a power pack which provides the power supply to the apparatus during a normal mode of operation. Such a transformer for a normal mode of operation should have comparatively large dimensions depending on its power rating. FIG. 1 of said patent document reveals a hand-held shaver, which forms the apparatus. The apparatus has a first and a second housing section. The first housing section accommodates a primary side of the transformer. The second housing section accommodates a secondary side of the transformer. In analogy with the transformer, a primary side of the power pack is also accommodated in the first housing section and a secondary side of the power pack is accommodated in the second housing section. Thus, in the known apparatus the primary side of the power pack is realized in a first printed circuit and the secondary side of the power pack is realized in a second printed circuit. The primary side of the power pack and the primary side of the transformer are secured in the first housing section. The secondary side of the power pack and the secondary side of the transformer are secured in the second housing section. The two housing sections each have a housing wall, which two housing walls face one another and form the insulating means between the primary side and the secondary side of the transformer and of the power pack and the printed circuit of the power pack, thereby guaranteeing compliance with safety regulations (IEC 60065) for the operation of the apparatus as laid down by international authorities, which safety regulations stipulate a minimum dielectric strength between the primary side and the secondary side of the transformer and a minimum distance between primary connection leads and secondary connection leads of the transformer. These safety regulations have been laid down in the standard IEC60065.

The use of such a known and comparatively large transformer for such a power pack in such an apparatus is justified for a normal mode of operation. When used in an apparatus having a standby mode, in which standby mode a power consumption below 2 W is required, the use of the known transformer in a standby mode is not justified because during such a use in such an apparatus a comparatively high power dissipation occurs and the standby power consumption is over 2 W. Moreover, a problem is that two housing walls, i.e. one housing wall for each of the two housing sections, are required in order to form the insulation means. A further problem is that owing to the realization of the insulation means with the aid of two facing housing walls the insulation means have a comparatively great thickness, because the housing walls should have at least a given strength, as a result of which it is not allowed to use a thickness of the housing walls and, consequently, of the insulation means smaller than that required for an adequate strength. This again has adversely affects the transient response of the transformer and thereby inhibits a miniaturization of the transformer so as to reduce the power consumption of the apparatus. Mounting the primary side of the transformer in the first housing section and mounting the secondary side of the transformer in the second housing section is a technically intricate and therefore uneconomical solution in order to maintain the minimum distance. Mounting the primary side of the printed circuit and the secondary side of the printed circuit in a housing section each constitutes a further problem because this doubles the mounting cost. In a transformer in accordance with the prior art a further problem is that when such a transformer is used in a switched-mode power supply a poor common mode behavior is obtained because a capacitive coupling between the primary side and the secondary side of the switched-mode power supply, which coupling is necessary for a satisfactory common mode behavior, can be realized only with difficulty and with correspondingly intricate technical measures. Altogether, it is therefore highly uneconomical to use the known transformer in a standby mode of an apparatus having such a standby mode.

It is an object of the invention to solve the afore-mentioned problems with a transformer of the type defined in the opening part of claim 1, and with a power pack of the type defined in the opening part of claim 5, and with an apparatus of the type defined in the opening part of claim 9, and to provide an improved transformer and an improved power pack as well as an improved apparatus which are particularly suitable for operation in a standby mode.

With a transformer as defined in the opening part of claim 1 the aforementioned object is achieved by the provision of the characteristic features as defined in the characterizing part of claim 1.

With a power pack as defined in the opening part of claim 5 the aforementioned object is achieved by the provision of the characteristic features as defined in the characterizing part of claim 5.

With an apparatus as defined in the opening part of claim 9 the aforementioned object is achieved by the provision of the characteristic features as defined in the characterizing part of claim 9.

By the provision of the characteristic features in accordance with the invention as defined in the claims 1, 5 and 9 it is advantageously achieved that a transformer of particularly small dimensions can be realized which is optimized for standby operation and which enables compliance with official safety regulations to be achieved in a space-saving, constructionally simple and cheap manner and which enables miniaturization to be realized in a technically simple manner, so that with the aid of such a transformer in accordance with the invention both a power pack in accordance with the invention and an apparatus in accordance with the invention can be realized in a comparatively cheap manner and both a power pack and an apparatus have an advantageous construction suitable for operation in a standby mode.

By the provision of the characteristic features in accordance with the invention as defined in the claims 2, 6 and 10 it is advantageously achieved that even in the case of a small distance between the primary end face and the secondary end face, which is determined by the mounting plate, a minimum dielectric strength in compliance with the safety regulations is guaranteed between the primary side of the transformer, i.e. the primary winding and the primary magnet core of the transformer, and the primary side of the transformer, i.e. the secondary winding and the secondary magnet core. In this respect it is particularly advantageous that a minimum distance in compliance with the safety regulations can be realized between the connection leads of the primary winding of the transformer and the secondary winding of the transformer merely by the dimensioning of the mounting plate.

By the provision of the characteristic features in accordance with the invention as defined in the claims 3, 7 and 11 it is advantageously achieved that the transformer intended for operation in a standby mode can be integrated wholly in a printed circuit. This is particularly advantageous when the transformer is constructed from SMD components because this also ensures an optimum handling of its parts in the case of a miniaturized transformer. A further advantage is obtained in that in this case the connection leads of the transformer windings can be connected mechanically and electrically to the mounting plate in a single process step simultaneously with other elements to be soldered to the printed circuit with the aid of a solder process which is customary for SMD mounting, for example with the aid of a reflow solder process.

By the provision of the characteristic features in accordance with the invention as defined in the claims 4, 8 and 12 it is advantageously achieved that screening of the primary side of the transformer with respect to the secondary side of the transformer can be realized in the simplest possible way. The recesses further yield the advantage that a transmission of magnetic flux between the at least one primary end face of the primary magnet core and the at least one secondary end face of the secondary magnet core is not influenced, wile at the same time an undesired capacitive coupling between the primary winding and the secondary winding can be reduced. A further advantage is obtained in that this screening considerably contributes to an improved common-mode behavior of the transformer.

The above-mentioned as well as further aspects of the invention will become apparent from the embodiment described hereinafter by way of example and will be elucidated with reference to this example.

The invention will now be described in more detail with reference to the drawings, which show an embodiment given by way of example but to which the invention is not limited.

FIG. 1 shows diagrammatically an apparatus in accordance with a first embodiment of the invention having a power pack with a transformer.

FIG. 2 is a cross-sectional view of the transformer of the apparatus shown in FIG. 1.

FIG. 1 shows an apparatus 1 having a housing 2 and a power supply device 3 and a load 4. The power supply device 3 and the load 4 are accommodated in a single housing 2. In the present case the apparatus 1 is formed by a television set.

A mains voltage U1 can be applied from an electric power mains, not shown, to the power supply device 3 with the aid of a first mains lead 5 and a second mains lead 6. In the present case the power supply device 3 is designed in such a manner that the mains voltage U1 can assume values between 80 and 260 V, which allows the apparatus 1 and the power supply device 3 to be used worldwide.

The apparatus 1 has a normal mode of operation and a standby mode. In the standby mode substantially all the functions available in the normal mode of operation of the apparatus 1 are deactivated and, as a consequence, an energy-saving standby power consumption from the power mains is guaranteed. In the present case the standby power consumption is approximately 150 mW. The functions of the apparatus 1 in the normal mode of operation will not be described in any further detail because they are not relevant to the invention.

Accordingly, the power supply device 3 is adapted to generate and supply a standby operating voltage U2 for powering the load 4 of the apparatus 1 in the standby mode and to generate and supply a normal-mode operating voltage U3 for powering the load 4 of the apparatus 1 in the normal mode of operation. For this purpose, the power supply device 3 has a normal-mode power supply device 7 and a standby power supply device 8, which standby supply device 8 is referred to hereinafter as the power pack 8.

The normal-mode power supply device 7 has an active state. In the active state the normal-mode power supply device 7 is adapted to consume electric power from the power mains and to generate the normal-mode operating voltage U3, as a result of which the load 4 is powered with the normal-mode operating voltage U3 and as a result of which the apparatus 1 is set to the normal mode of operation. The normal-mode power supply device 7 further has an inactive state. In the inactive state the normal-mode power supply device 7 is adapted not to consume any power from the power mains and the normal-mode operating voltage U3 is not generated, as a result of which the load 4 receives the standby supply voltage U2 and as a result of which the apparatus 1 is set to the standby mode. Furthermore, the normal-mode power supply device 7 is connected to the load 4 via a control line SL and is adapted to receive an activation signal AS and a deactivation signal DS via this control line SL. With the aid of the activation signal AS the normal-mode power supply device 7 can be set to its active state and with the aid of the deactivation signal DS it can be set to its inactive state.

The power pack 8 has a first mains lead input 9 and a second mains lead input 10. The power pack 8 has its first mains lead input 9 and its second mains lead input 10 connected to the first mains lead 5 and to the second mains lead 6 and thus to the mains voltage U1. The power pack 8 further has a primary side 11 and a secondary side 12 and a transformer 13. The power pack 8 further has a first power pack output 14a and a second power pack output 14b, the standby operating voltage U2 for powering the load 4 in the standby mode of the apparatus 1 appearing across the first power pack output 14a and the second power pack output 14b when the mains voltage U1 is available. The primary side 11 has means, not shown in FIG. 1, for generating a primary voltage U4. In the present case, the means for generating the primary voltage U4 include a switched-capacitor power supply having input filters and a tuned push-pull converter. In this respect, it is to be noted that instead of a tuned push-pull converter it is likewise possible to use a flyback converter, but in that case the efficiency of the power pack 8 is less favorable.

The transformer 13 has a first primary connection lead 15 and a second primary connection lead 16, to which the primary voltage U4 can be applied. The transformer 13 further has a first secondary connection lead 17 and a second secondary connection lead 18. The transformer can supply a secondary voltage U5 across these two connection leads 17 and 18 to the secondary side 12 of the power pack 8. The secondary side 12 is adapted to generate and to supply the standby operating voltage U2 from the secondary voltage U5. In the present case, the means included in the secondary side 12 for generating the standby operating voltage U2 take the form of a push-pull rectifier. In this respect, it is to be noted that said means may alternatively take the form of a bridge rectifier.

The standby operating voltage U2 can be applied to the load 4, the standby operating voltage U2 serving to power receiving means included in the load 4 and not shown in FIG. 1. In the present case, the receiving means include an infrared sensor for receiving infrared signals. The receiving means further include a microprocessor for processing the infrared signals received by the infrared sensor. The microprocessor is further adapted to generate and to supply the activation signal AS and the deactivation signal DS. When infrared signals are received by means of the infrared sensor infrared signals which serve to activate the normal mode of operation of the apparatus 1 may appear. When such infrared signals are processed the microprocessor supplies the activation signal AS to the normal-mode power supply device 7. Thus, the normal-mode power supply device 7 is set to the active state and the normal-mode power supply device supplies the normal-mode operating voltage U3 to the load. The apparatus 1 is consequently in the normal mode of operation. However, the receiving means can also receive infrared signals which serve to set the apparatus 1 to the standby state. When such infrared signals are processed the microprocessor supplies the deactivation signal DS to the normal-mode power supply device 7, upon which the generation and supply of the normal-mode operating voltage U3 in normal-mode power supply device 7 is terminated. After this, the apparatus 1 is in the standby mode. In the standby mode the apparatus 1 merely waits for an infrared signal that can be applied to the apparatus 1 by an infrared transmitter, not shown in FIG. 1.

The transformer 13 of the apparatus 1 will now be described with reference to FIG. 2. The transformer 13 has a primary winding 19, to which the primary voltage U4 can be applied. For this purpose, the first primary connection lead 15 and the second primary connection lead 16 of the primary winding 19 are led out of the transformer 13. The transformer 13 further has a secondary winding 20, from which the secondary voltage U5 can be taken. For this purpose, the first secondary connection lead 17 and the second secondary connection lead 18 of the secondary winding 20 are led out of the transformer 13.

The transformer 13 further has a primary magnet core 21 adapted to carry the primary winding 19. In the present case, the primary magnet core 21 has three primary end faces 24.

The transformer 13 further has a secondary magnet core 23 adapted to carry the secondary winding 20. In the present case, the secondary magnet core 23 has three secondary end faces 24.

In the transformer 13 the three primary end faces 22 and the three secondary end faces 24 face one another with an intermediate gap 25. In the gap 25 insulation means have been provided. The insulation means serve to comply with statutory safety regulations. Advantageously, the insulation means in the gap 25 of the transformer 13 are formed with the aid of a mounting plate 26, which is suitable as a mounting plate 26 for a printed circuit, which is not shown in FIG. 1. The mounting plate 26 has a plate thickness D of 0.2 mm. As a result of this, the gap 25 between the primary end faces 22 and the secondary end faces 24 can be comparatively small. In the present case, the mounting plate 26 is made of an epoxy material, as a result of which a dielectric strength of over 10 kV is obtained even with a plate thickness D as small as 0.2 mm. Furthermore, the use of the mounting plate 26 in order to realize the insulation means has the advantage that during operation of the transformer 13 the small plate thickness D between the primary end faces 22 and the secondary end faces 24 has a positive influence on the magnetic coupling in the area of these end faces 22 and 24. This is because during operation of the transformer 13 a stray inductance is formed owing to the presence of the gap 25 between the end faces 22 and 24, the value of this stray inductance being minimized as a result of the small plate thickness D. This measure further results in magnetic losses occurring in the area of the gap 25 being minimized. In addition, the presence of the stray inductance is favorable for the use of the tuned push-pull converter in the primary side 11 of the power pack 8.

For the dimensioning of the volume of the magnet core, which is formed by the primary magnet core 21 and the secondary magnet core 23 and which should have a given volume for the transmission of power between the primary winding 19 and the secondary winding 20, this means first of all that the volume of the magnet core can be adapted to a power value which is typically very small for a standby mode. In the present case, the output power to be supplied by the power pack 8 is approximately 150 mW. A low-cost construction of the magnet core is obtained by means of a magnet core of the type ER9.5, said magnet core being over-dimensioned from a purely magnetic point of view. In the present case, a limitation is imposed by a choice of wire suitable for the formation of the primary winding 19 and the secondary winding 20. In the present case, the wire has a very small diameter of 0.05 mm, as a result of which the primary winding 19 and the secondary winding 20 can be made without any problems by means of a machine.

As regards the primary magnet core 21 and the secondary magnet core 23 it is to be noted that it is likewise possible to use other types, namely an RM type, an ER8.9 type, an EE8 type, a P type or a U type. These are the current magnet core types at the moment. However, it is to be noted that magnet cores which differ from the current types can be used, which magnet cores may advantageously have volumes which are smaller as compared with the current types.

The transformer 13 further has a primary coil former 27 for supporting the primary winding 19. The transformer 13 further has a secondary coil former 28 for supporting the secondary winding 20. In the present case, the two coil formers have a wall thickness W of 0.3 mm. The coil formers 27 and 28 enable the primary winding 19 and the secondary winding 20 to be manufactured, transported and mounted on the mounting plate 26 by a machine in the simplest possible manner. In the present case, this is effected by means of an SMD placement machine. However, it is to be noted in view of miniaturization of the transformer 13 it is also possible to dispense with the primary coil former 27 and the secondary coil former 28. In that case, the primary winding 19 and the secondary winding 20 take the form of air-core coils. This is primarily of interest because the costs for the two SMD mountable coil formers 27 and 28 are quite comparable to those of the two magnet cores 21 and 23.

The mounting plate has a first terminal pad 30 and a second terminal pad 31 at its side which faces the primary winding 19. The first primary connection lead 15 is connected to the first terminal pad 30. The second primary connection lead 16 is connected to the second terminal pad 31. At its side which faces the secondary winding 20 the mounting plate 25 has a third terminal pad 32 and a fourth terminal pad 33. The first secondary connection lead 17 is connected to the third terminal pad 32. The second secondary connection lead 18 is connected to the fourth terminal pad 33. In the present case, the connections between the individual primary connection leads 15 and 16 and the associated terminal pads 30 and 31 and between the individual secondary connection leads 17 and 18 and the associated terminal pads 32 and 33 are made by means of a solder process with the aid of a solder bath. However, it is to be noted that the connections can also be made by ultrasonic bonding or by soldering with the aid of a high-power discharge.

The mounting plate 26 has a such a dimension P in the plane of the plate that a minimum distance M in all directions and, consequently, a minimum dielectric strength is guaranteed between parts of the transformer 13 which are connected to the primary voltage U4 and parts of the transformer 13 which are connected to the secondary voltage U5. The parts of the transformer 13 which are connected to the primary voltage U4 include all the parts of the transformer 13 disposed at the side of the mounting plate 26 which faces the primary winding 19, as well as the first terminal pad 30 and the second terminal pad 31. The parts of the transformer 13 which are connected to the secondary voltage U5 include all the parts of the transformer 13 which are disposed at the side of the mounting plate 26 which faces the secondary winding 20, as well as the third terminal pad 32 and the fourth terminal pad 33.

The mounting plate 26 is a part of a printed circuit. Accordingly, conductor tracks are provided at the side of the mounting plate 26 which faces the primary winding 19. Portions of these conductor tracks form the first terminal pad 30 and the second terminal pad 31. With the aid of these conductor tracks it is further possible to realize the tuned push-pull converter of the primary side 11 of the power pack 8 in the direct vicinity of the primary winding 17. Particularly in view of high operating frequencies of the push-pull converter which occur during operation of the power pack 8 this is a major advantage.

Furthermore, conductor tracks are provided at the side of the mounting plate 26 which faces the secondary winding 20. Portions of these conductor tracks form the third terminal pad 32 and the fourth terminal pad 33. With the aid of the conductor tracks the push-pull rectifier of the secondary side 12 of the power pack 8 is realized at this side of the mounting plate 26.

A further advantage of the provision of conductor tracks on the mounting plate 26 is that primary side and secondary side terminal pads, which are not shown in FIG. 2, are provided along an edge portion of the mounting plate 26 for contact engagement of the primary side 11 and the secondary side 12 of the power pack 8 accommodated on the mounting plate 26 with a so-called flex connector. This enables the printed circuit accommodated on the mounting plate 26 to be connected to the power supply device 3 in the simples possible way.

In this respect it is to be noted that the dimension P of the mounting plate 26 guarantees the minimum distance M both between the conductor tracks of the side of the mounting plate 26 which face the primary winding 19 and the conductor tracks of the side of the mounting plate 26 which face the secondary winding 20, and between those of primary side 11 of the power pack 8 and the secondary side 12 of the power pack 8, i.e. also between the primary side terminal pads and the secondary side terminal pads.

Furthermore, it is to be noted that on account of safety regulations a bracket-like or clip-like mounting device may be provided which, on the one hand, securely connects the primary magnet core 21 and the secondary magnet core 23 to the mounting plate 26 and, on the other hand, holds the primary magnet core 21 and the secondary magnet core 26 in a well-defined position on the mounting plate 26. This mounting device may further have anchoring elements which enable the mounting plate 26 to be mechanically connected to the power supply device 3 in a secure and reliable manner.

At its side which faces the primary magnet core 21 the mounting plate 26 carries a first conductive layer 34, which has recesses 35 at the primary side for the three primary end faces 22. At its side which faces the secondary magnet core 23 the mounting plate 26 carries a second conductive layer 36, which has recesses 37 at the secondary side for the three secondary end faces 24. The first conductive layer 34 and the second conductive layer 36 are also formed as conductor tracks of the printed circuit. The first conductive layer 34 has a planar shape which is essentially congruent with a projection of an outline, parallel to the plane of the mounting plate 26, of the primary winding 19 onto the mounting plate 25. The second conductive layer 36 has a planar shape which is essentially congruent with a projection of an outline, parallel to the plane of the mounting plate 26, of the secondary winding 20 onto the mounting plate 25. In contradistinction to these two projections, however, the first conductive layer 34 and the second conductive layer 36 do not have a continuous circular structure. The circular structure of the projection is interrupted in the first conductive layer 34 and in the second conductive layer 36. The first conductive layer 34 is connected to a first grounding point of the primary side 11 of the power pack 8. The second conductive layer 36 is connected to a second grounding point of the secondary side 12 of the power pack 8. The configuration of the first conductive layer 34 and the second conductive layer 36 ensures that a magnetic flux which appears between the at least one primary end face 22 and the at least one secondary end face 24 during operation of the transformer can traverse the mounting plate 26 unimpeded. However, at the same time the afore-mentioned configuration of the first conductive layer 34 and the second conductive layer 36 essentially precludes an inadvertent capacitive coupling between the primary winding 19 and the secondary winding 20 during operation of the transformer. Thus, the first conductive layer 34 and the second conductive layer 36 act as screening means against a capacitive coupling between the primary winding 19 and the secondary winding 20. At the frequencies which occur during operation of the power pack 8 the first conductive layer 34 and the second conductive layer 36 with their connections provide a decisive contribution to the possibility of constructing the afore-mentioned filters of the primary side 11 of the power pack 8 in the simplest and cheapest possible way. Thus, with the aid of the configuration of the first conductive layer 34 and the second conductive layer 36 it is achieved in a simple and cheap manner that spurious voltages on the mains voltage U1 do not exceed a statutorily prescribed frequency dependent maximum value.

Furthermore, it is to be noted that the secondary winding 20 may have more than two secondary connection leads, thereby enabling more standby operating voltages to be generated with the aid of the power pack 8. As regards the primary magnet core 21 and the secondary magnet core 23 it is to be noted that their structures are not limited to the aforementioned types because simpler and smaller versions may give a decisive cost reduction in the case of correspondingly large numbers.

In a particularly cheap case an apparatus 1 including a power pack 8 for the generation of a standby operating voltage U2 and employing a transformer 13 it is even possible to do dispense with the primary magnet core 21 and the secondary magnet core 23. In this case only air-core coils are to be used for the primary winding 19 and the secondary winding 20, but the efficiency is not as high as in the case of the transformer 13 having the magnet cores 21 and 23.

1. A transformer (13) having the means defined hereinafter, i.e.
a primary winding (19), to which a primary voltage (U4) can be applied,
a secondary winding (20), from which at least one secondary voltage (U5) can be taken, and
a primary magnet core (21), which is adapted to carry the primary winding (19) and which has at least one primary end face (22), and
a secondary magnet core (23), which is adapted to carry the secondary winding (20) and which has at least one secondary end face (24),
the at least one primary end face (22) and the at least one secondary end face (24) facing one another with an intermediate gap (25), and insulation means in the gap, characterized in that the insulation means are formed with the aid of a mounting plate (26) which is suitable as a mounting plate for a printed circuit.

2. A transformer (13) as claimed in claim 2, characterized in that the mounting plate (26) has a such a dimension (P) that a minimum distance (M) is guaranteed between parts (15, 16, 19, 21, 27, 34) of the transformer (13) which are connected to the primary voltage (U4) and parts (17, 18, 20, 23, 28, 36) of the transformer (13) which are connected to the secondary voltage (U5).

3. A transformer (13) as claimed in claim 1, characterized in that the mounting plate (26) forms part of a printed circuit.

4. A transformer (13) as claimed in claim 1, characterized in that
the mounting plate (26) has a first conductive layer (34) at its side which faces the primary magnet core (21), which layer has a primary-side recess (35) for the at least one primary end face (22), and
the mounting plate (26) has a second conductive layer (36) at its side which faces the secondary magnet core (23), which layer has a secondary-side recess (37) for the at least one secondary end face (24).

5. A power pack (8) having a transformer (13), which transformer (13) has the means defined hereinafter, i.e.
a primary winding (19), to which a primary voltage (U4) can be applied,
a secondary winding (20), from which at least one secondary voltage (U5) can be taken, and
a primary magnet core (21), which is adapted to carry the primary winding (19) and which has at least one primary end face (22), and
a secondary magnet core (23), which is adapted to carry the secondary winding (20) and which has at least one secondary end face (24),
the at least one primary end face (22) and the at least one secondary end face (24) facing one another with an intermediate gap (25), and insulation means in the gap, characterized in that the insulation means are formed with the aid of a mounting plate (26) which is suitable as a mounting plate for a printed circuit.

6. A power pack (8) as claimed in claim 5, characterized in that the mounting plate (26) has a such a dimension (P) that a minimum distance (M) is guaranteed between parts (15, 16, 19, 21, 27, 34) of the transformer (13) which are connected to the primary voltage (U4) and parts (17, 18, 20, 23, 28, 36) of the transformer (13) which are connected to the secondary voltage (U5).

7. A power pack (8) as claimed in claim 6, characterized in that the mounting plate (26) forms part of a printed circuit.

8. A power pack (8) as claimed in claim 7, characterized in that
the mounting plate (26) has a first conductive layer (34) at its side which faces the primary magnet core (21), which layer has a primary-side recess (35) for the at least one primary end face (22), and
the mounting plate (26) has a second conductive layer (36) at its side which faces the secondary magnet core (23), which layer has a secondary-side recess (37) for the at least one secondary end face (24).

9. An apparatus (1) having a transformer (13), which transformer (13) has the means defined hereinafter, i.e.
a primary winding (19), to which a primary voltage (U4) can be applied,
a secondary winding (20), from which at least one secondary voltage (U5) can be taken, and
a primary magnet core (21), which is adapted to carry the primary winding (19) and which has at least one primary end face (22), and
a secondary end face (23), which is adapted to carry the secondary winding (20) and which has at least one secondary end face (24),
the at least one primary end face (22) and the at least one secondary end face (24) facing one another with an intermediate gap (25), and
insulation means in the gap, characterized in that the insulation means are formed with the aid of a mounting plate (26) which is suitable as a mounting plate for a printed circuit.

10. An apparatus (1) as claimed in claim 9, characterized in that the mounting plate (26) has a such a dimension (P) that a minimum distance (M) is guaranteed between parts (15, 16, 19, 21, 27, 34) of the transformer (13) which are connected to the primary voltage (U4) and parts (17, 18, 20, 23, 28, 36) of the transformer (13) which are connected to the secondary voltage (U5).

11. An apparatus (1) as claimed in claim 10, characterized in that the mounting plate (26) forms part of a printed circuit.

12. A apparatus (1) as claimed in claim 11, characterized in that
the mounting plate (26) has a first conductive layer (34) at its side which faces the primary magnet core (21), which layer has a primary-side recess (35) for the at least one primary end face (22), and
the mounting plate (26) has a second conductive layer (36) at its side which faces the secondary magnet core (23), which layer has a secondary-side recess (37) for the at least one secondary end face (24).
